(19) United States
(12) Patent Application Publication
(10) Pub. No.: US 2007/0087624 A1
(43) Pub. Date: Apr. 19, 2007

(54) Rooftop electrical boot

(76) Inventor: Larry F. Edwards, Boulder, IL (US)

Correspondence Address: Peter R. Bahn;Patent Attorney, 10415 E. Boyd Rd., Mt. Vernon, IL, 62864, US

(21) Appl. No.: 11/249,844

(22) Filed: Oct. 14, 2005

(51) Int. Cl. H01R 13/73

(52) U.S. Cl. 439/559

(57) ABSTRACT

A rooftop electrical boot for electrical service entrance to a building is described which allows it to be installed on a building without the electric power to the building being shut off and without the need to hire an electrician to connect or to disconnect electric power lines to the building. This goal is achieved with a boot containing a sealable slit that allows access to the electric conduit hole of the boot from outside the boot's base without the need to thread power lines through the hole itself.

### BACKGROUND OF THE INVENTION

This invention relates to the general art category of roof construction and roof repair. This invention relates more specifically to materials for preparing roofs for electrical service entrances to buildings. To be more precise, this invention is a rooftop electrical boot, meant primarily to be a rooftop replacement boot for electrical service entrance for buildings, although this invention can also be used as a new rooftop electrical boot.

A standard rooftop electrical boot is a single piece of flexible rubber molded to have a flat base from which rises an oval protuberance the top of which has hole in it. The rooftop electrical boot is used to make a watertight seal or barrier around a pipe through which electric power cables or wires are run into a building. Such rooftop electrical boots are usually surrounded by roof shingles, which also must provide a watertight seal for the roof, particularly in the location where the electrical boot is placed.

When replacing shingles on a roof in the area of the electrical service entrance, the existing old boot must be carefully removed from the shingles. Because the electrical wires are threaded through the hole of the boot, to replace a boot or to apply a new boot to a roof, the electric power to the entire building must be shut off first by the electric power company. An electrician must be employed to remove the wires and service head so a new or replacement boot can be put on the roof. This is a very expensive and cumbersome process which may cost a few hundred dollars, and all because the standard boot is topologically threaded through its hole by wire, and cannot be unthreaded, replacement threaded, or newly threaded without either destroying the electrical boot or without the aid of the power company and an electrician who must also shut off the power to the building to do the job.

Destruction of a standard electrical boot is not a big issue as such standard boots usually cost less than $10. However, applying a new boot still requires the cumbersome and expensive power company and electrician intervention, even thought the new boot, again, is itself inexpensive. Thus, the main problem with stand rooftop electrical boots is that separating the boot from the wire can only be accomplished by destroying the boot or by unthreading it in a complicated manner. In addition, threading a new boot with wires can only be done in a complicated manner. This cumbersome process happens essentially because, topologically, the standard boot is like a donut, and the wire through the donut hole cannot pass through the hole boundaries of the donut without destroying the donut.

The object of the present invention is to solve the above problem by making a boot which possesses a slit bordered by closable and sealable flaps at a point of ingress and egress from the hole of the boot, so that wires can be put into or taken out of the hole by putting the wire through the closable sealable gap into the hole of the boot without the need to thread or rethread wire thought the hole of the boot.

### BRIEF SUMMARY OF THE INVENTION

The invention presented here looks like a standard rooftop electrical boot in the following manner. The boot presented here is made out of flexible rubber. The boot has a flat base out which arises a central oval protuberance with a hole in it. However, the hole is not a true topological donut type of hole in the sense that the boot also has a slit with two opening and overlapping lips that allow ingress and egress from outside the base of the boot into the central hole of the boot, and which lips are sealed with a sealant once the boot is in place as desired by the roof personnel. No electrician is needed and no power shut-off is required in the use of the boot described herein.

### BRIEF DESCRIPTION OF THE DRAWINGS

The standard prior art, the improvement in such art as represented in the present invention, and the method of using the present invention are shown in the accompanying drawings.

FIG. 1 shows a perspective view of how electrical power lines from a power utility pole are conducted into a house while being threaded through a standard boot.

FIG. 2 shows a close up top view of a standard boot with roof shingles placed around it.

FIG. 3 shows an overhead close up view of the present invention, with two overlapping flaps that define a slit in the present boot that allow non-destructive access to the hole of the boot.

FIG. 4 shows a side view of the present boot invention.

FIG. 5 shows a down roof view of the present boot invention.

### DETAILED DESCRIPTION OF THE INVENTION

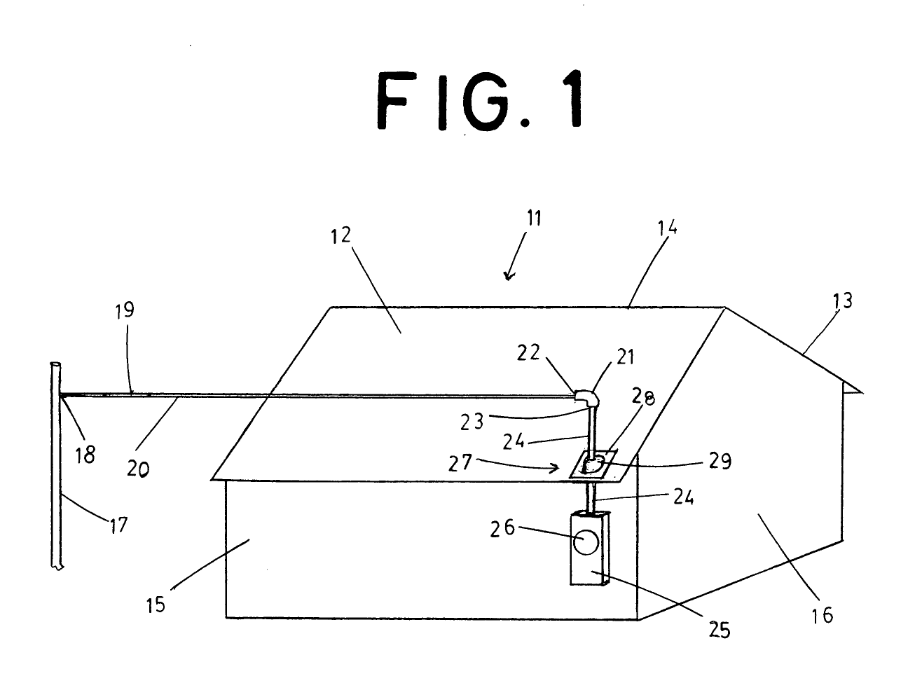

Referring now to FIG. 1, we see a power company utility pole 17, along which at location 18 are connected electrical power lines 19 and 20. The power cables are connected to a typical residential house 11, which has sides 15 and 16, and a roof 14 comprised of its two sides 12 and 13. The power lines 19 and 20 pass over part of roof side 12 to enter at location 22 of the service head 21 and to exit it at location 23, which leads to the top section of electric conduit pipe 24. The pipe 24 passes through a standard rooftop electrical boot 27, the boot 27 being comprised of its base 28 and its protuberance 29. The bottom part of the pipe 24 connects to the electrical power meter housing 25 of the house, which contains the electrical power meter 26 of the house 11. Thus, the electrical wires 19 and 20 pass through the pipe 24 into the electrical power meter housing 25.

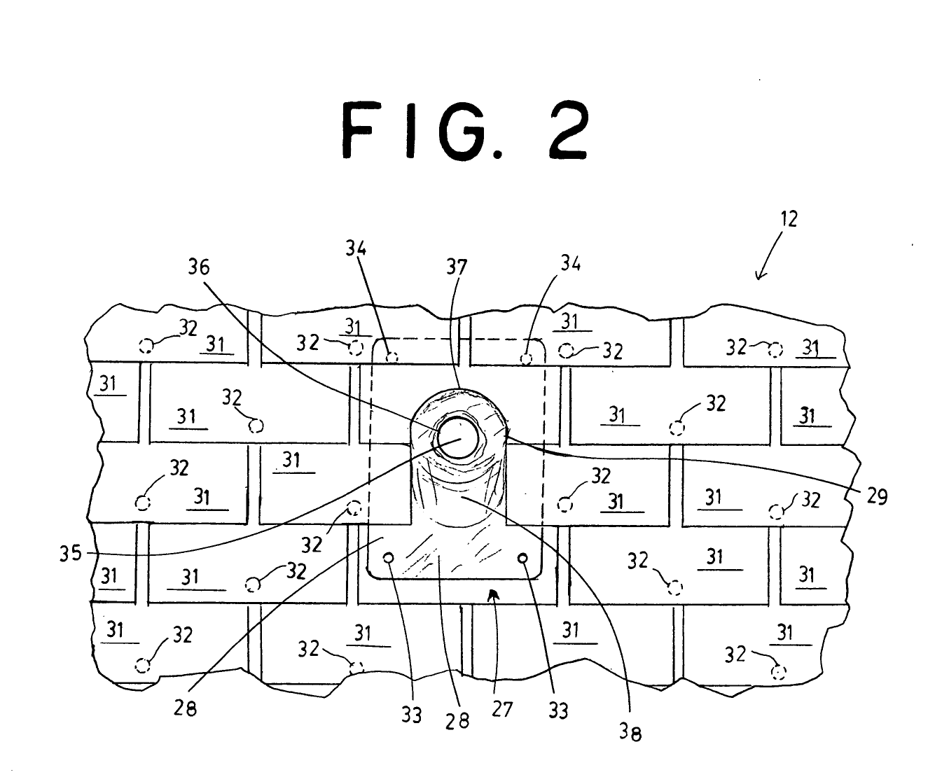

Referring now to FIG. 2, we see the standard boot 27 in more detail. The boot 27 has a flat base 28 from which arises an oval protuberance 29. At the top of the protuberance 29 is a hole 35 with a circular boundary 36. The rounded top 37 of the protuberance 29 pointing towards the top of the roof and the stretched out rounded bottom 38 of the protuberance 29 pointing towards the bottom of the roof are shown.

The boot 27 is held down to the roof surface 12 by four nails, one in each corner of the boot 27. The two nails 33 at the bottom of the boot are exposed while the two nails 34 at the top of the boot 27 are concealed by two shingles 31.

Around the four sides of the boot 27 are various other roof shingles 31 which are held down to the roof surface by various nails 32 that are concealed by other shingles 31. The arrangement of the shingles 31 and the boot 27 are arranged in a downward overlapping manner so as to prevent leaking of water though the roof surface 12. Also, when the shingles 31 and the boot 27 have been finally installed on the roof surface 12, waterproof caulking is applied to the seam between the top surface 37 of the boot and its contacting shingle, and the caulk is also applied to cover the exposed bottom nails 33 holding the boot 27 onto the roof surface 12.

A naïve attempt to solve the topological problem the solution of which forms the basis of this invention might be voiced as follows. Why not take a standard boot 27 and cut the boot in a straight line fashion from the hole boundary 36 along the bottom 38 of the protuberance all the way the bottom down roof side of the boot base 28? That way, the topological threading problem could be avoided, and after it proper placement around the service pipe 24, the boot 27 could then be resealed along the straight cut to the down roof side of the boot. This naïve solution would not work, because a standard boot is made of flexible molded rubber 1/16 of an inch thick, and even when the two sides of the cut were closed with a sealant adhesive, the cut would soon open from with weather-related stresses, and water would then leak through the open cut into the underside of the roof. Thus, there is no good way to reconfigure a standard boot like 27 to get around the topological problem.

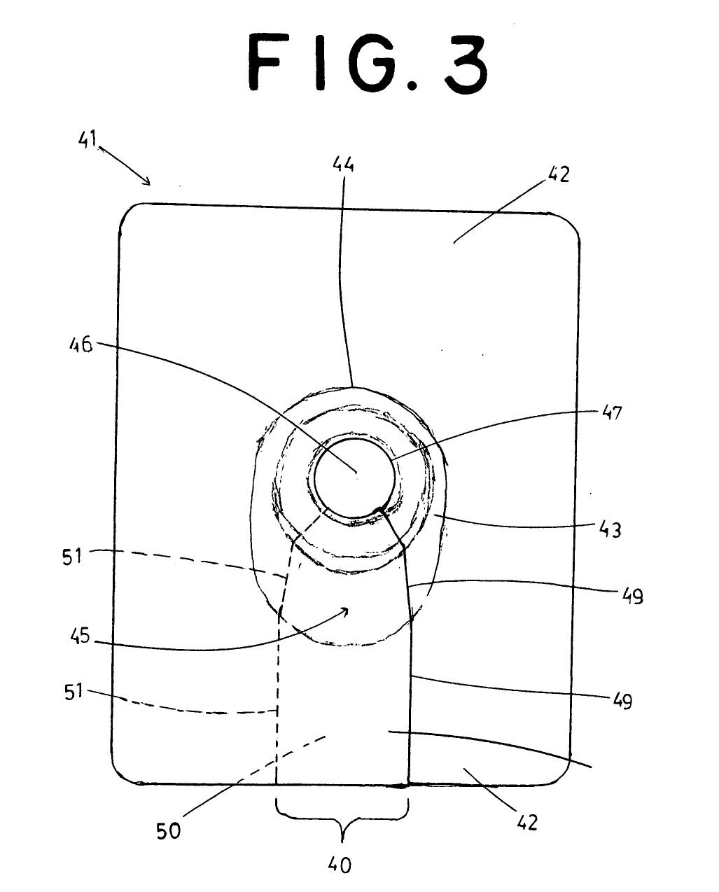

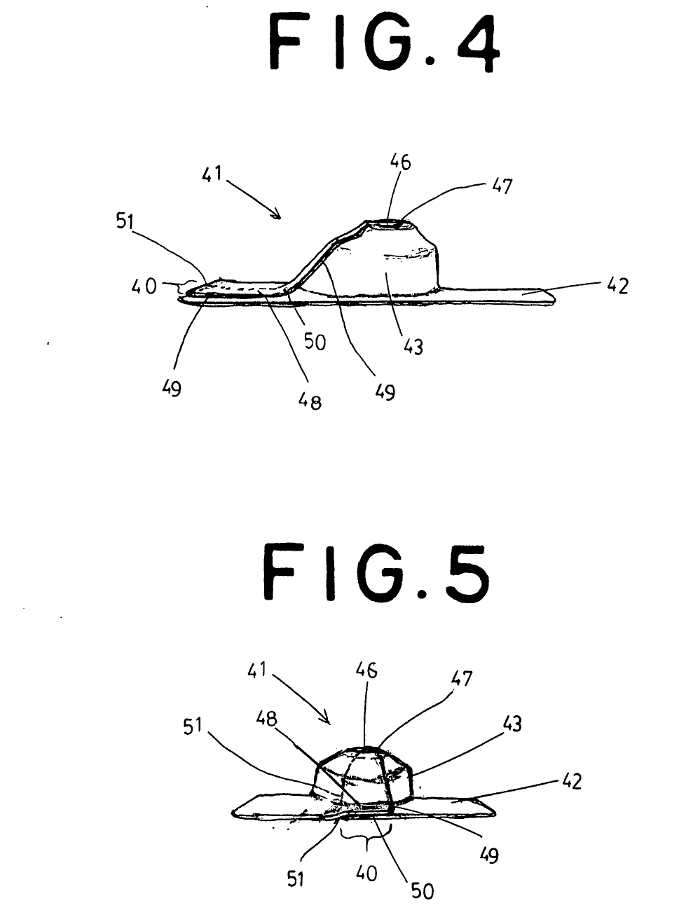

In FIGS. 3, 4, and 5 are shown respectively overhead, side, and down roof views of a rooftop electrical boot 41 that constitutes the present invention. This boot 41 looks very much like a standard boot at a surface level. Although this boot can made in different sizes, a typical size of this invention to be used on residential roofs has the following measurements: The boot 41, has a flat essentially rectangular base 42 measuring 11.5 inches long by 9 inches wide. The boot is made from flexible rubber 1/16 inch thick. From the center of the base 42 arises an oval protuberance 43, rounded at the up roof side 44 and more stretched out and rounded at the down roof side 45. The protuberance 47 is 5 inches long and 3.25 inches wide. The protuberance 43 rises 2.75 inches above the surface of base 42 of the boot 41. At the top of the protuberance 43 is a hole 46 bounded by the circular rubber surface 47. The hole 46 is 1.375 inches in diameter.

However, unlike the case with a standard boot which must be threaded, this boot 41 possesses a down roof opening or slit 40 between two overlaying flaps 48 and 50, with their respective edges 49 and 51, that open up if the base 42 of the boot 41 is temporarily twisted a bit to allow access to the hole 46 from the down roof border of the base 42. The normally closed flaps 48 and 50 overlap each other to a width of 2.75 inches.

This boot 41 can be used as an original boot on a new roof or as a replacement boot for an old roof. If this boot 41 is used as a replacement boot, then the old existing boot is first completely removed. Then, in either case, this boot 41 is used as follows: The boot is bent to allow access to the hole 46 so that the hole 46 is slid around the electrical conduit pipe that carries the electric power lines. Double sided adhesive rubber roofing seam tape is cut in the pattern of overlapping flaps 48 and 50 but with 0.25 inches of the seam tape extending out from under the lip 49 of the top flap 48. While supporting the underside of the boot 41, the seam tape is pressed on its exposed sticky side firmly onto the top surface of the bottom flap 50. The seam tape cover paper is removed, and then the two flaps 48 and 50 are pressed together, leaving the extra 0.25 inch margin of the seam tape exposed. Thus a watertight seal is formed with this invention around the hole 46 of this boot 41. The boot 41 is then attached to a roof and shingled accordingly as with a standard boot, and appropriate caulking applied.

What is claimed is:

1. A rooftop electrical boot comprising a flat base from which arises a protuberance containing a hole, the said boot also possessing a slit through the base and protuberance to the said hole.

2. A rooftop electrical boot as described in claim one wherein the said slit is lined by two overlaying flaps that can be sealed to form a watertight barrier around the said hole.

3. A rooftop electrical boot as described in claim 1 wherein the said boot is comprised of a water-impermeable flexible material.

4. A rooftop electrical boot as described in claim 2 wherein the said boot is comprised of a water-impermeable flexible material.

5. A rooftop electrical boot as described in claim 3 wherein the said water-impermeable flexible material is rubber.

6. A rooftop electrical boot as described in claim 4 wherein the said water-impermeable flexible material is rubber.

7. A rooftop electrical boot as described in claim 1 wherein the said flat base of the boot is essentially rectangular in shape and the said protuberance of the boot is essentially oval in shape.

8. A rooftop electrical boot as described in claim 2 wherein the said flat base of the boot is essentially rectangular in shape and the said protuberance of the boot is essentially oval in shape.

9. A rooftop electrical boot as described in claim 3 wherein the said flat base of the boot is essentially rectangular in shape and the said protuberance of the boot is essentially oval in shape.

10. A rooftop electrical boot as described in claim 4 wherein the said flat base of the boot is essentially rectangular in shape and the said protuberance of the boot is essentially oval in shape.

11. A rooftop electrical boot as described in claim 5 wherein the said flat base of the boot is essentially rectangular in shape and the said protuberance of the boot is essentially oval in shape.

12. A rooftop electrical boot as described in claim 6 wherein the said flat base of the boot is essentially rectangular in shape and the said protuberance of the boot is essentially oval in shape.
